(19) United States
(12) Patent Application Publication
(10) Pub. No.: US 2007/0063889 A1
(43) Pub. Date: Mar. 22, 2007

(54) Phased array radar

(75) Inventor: Anthony Peter Hulbert, Southampton (GB)

Correspondence Address: CROWELL & MORING LLP;INTELLECTUAL PROPERTY GROUP, P.O. BOX 14300, WASHINGTON, DC, 20044-4300, US

(73) Assignee: Roke Manor Research Limited, Romsey (GB)

(21) Appl. No.: 11/507,480

(22) Filed: Aug. 22, 2006

(30) Foreign Application Priority Data
Aug. 31, 2005 (GB) 0517680.5
Mar. 3, 2006 (GB) 0604303.8

(51) Int. Cl. G01S 13/42

(52) U.S. Cl. 342/140; 342/188; 342/160; 342/131; 342/132; 342/134; 342/189; 342/139; 342/154; 342/157; 342/158

(57) ABSTRACT

A phased array radar comprises a first array (2) of detectors (6) in a first dimension; and a second array (1) of detectors (6) in a second, orthogonal, direction. The first array of detectors both transmits (8) and receives (9) and the second array of detectors only receives (7). The first array resolves in range and either azimuth, or elevation; whereas the second array is a staring array that stares at targets at specified ranges determined by the first array, and the second array resolves in the other of elevation or azimuth, accordingly.

Monostatic phased array radars may be required to detect targets in range and azimuth and also to determine the angle of elevation of a target. Traditionally, electronically steered or scanned radars that need to perform both functions consist of a planar array of N by M elements where there are M rows each consisting of N elements and where N and M are typically similar figures, e.g. order 20. This approach has two disadvantages. Firstly, the total number of elements required is large (about 400 in this example) and secondly, the beam must be raster scanned over all angular cells to cover the solid angle of interest. This can take considerable time as the number of two dimensional angular cells is large.

Although, the second problem of raster scanning over all angular cells can be mitigated or even overcome through the use of multiple beams or a staring array in which the vertical dimension of the array has all angles viewed simultaneously for reception purposes, to allow satisfactory operation in this way, the transmit beam must have good coverage at all elevation angles so that the returns can be viewed contemporaneously from all directions. However, this approach involves considerable further complexity.

In accordance with the present invention, a phased array radar comprises a first array of detectors in a first dimension; and a second array of detectors in a second, orthogonal, direction; wherein the first array of detectors both transmits and receives and the second array of detectors only receives; wherein the first array resolves in range and either azimuth or elevation; wherein the second array is a staring array that stares at targets at specified ranges determined by the first array; and wherein the second array resolves in the other of elevation or azimuth, accordingly.

The phased array responds to a distant image and generates signals at each detector in response to radar returns. Using orthogonal arrays of detectors reduces the processing requirement by deriving the range from the first scan and setting this value for the orthogonal scan, so that the second array only has to resolve in elevation or azimuth, whichever was not determined by the first array.

Preferably, the first and second arrays are arranged as a crossed array formed of both horizontal and vertical arrays; and wherein the horizontal array scans in azimuth, so that the vertical array only needs to scan in elevation.

Preferably, the staring array is a vertical array.

The staring array is able to look in all directions at once which makes processing more complex in a conventional phased array, but by setting the range from the value determined by the horizontal array, this processing complexity is reduced.

Preferably, the staring array images at a determined range cell, plus or minus one range measurement cell.

There may be a slight variation of apparent range with angle, so a margin is applied to the desired range cell.

An example of a phased array radar according to the present invention will now be described with reference to the accompanying drawings in which:

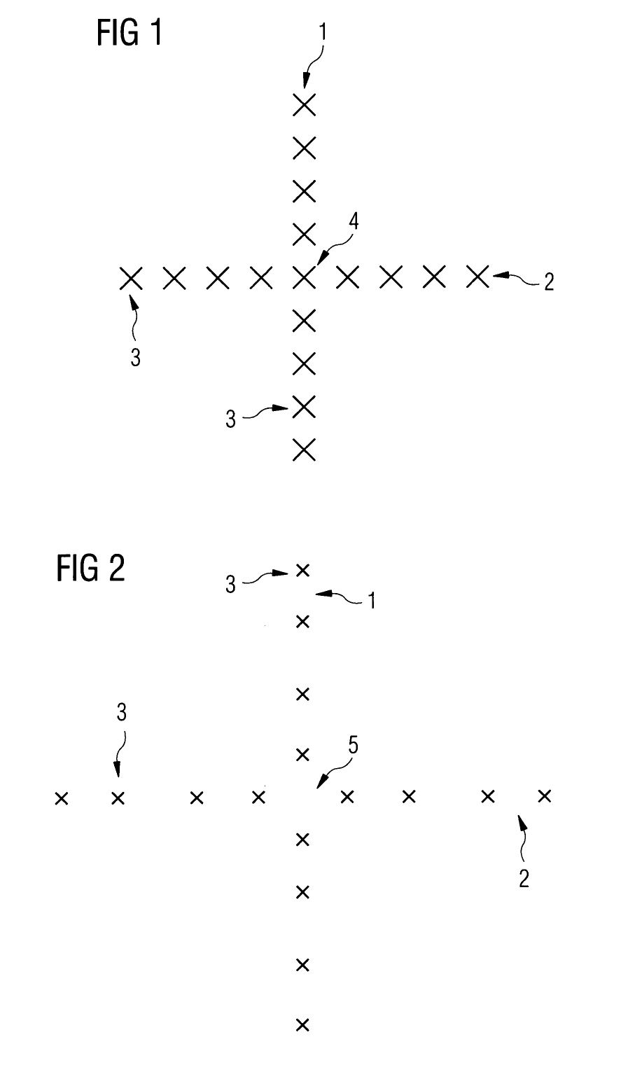

FIG. 1 illustrates a first example of an array for a radar according to the present invention;

FIG. 2 illustrates a second example of an array for a radar according to the present invention;

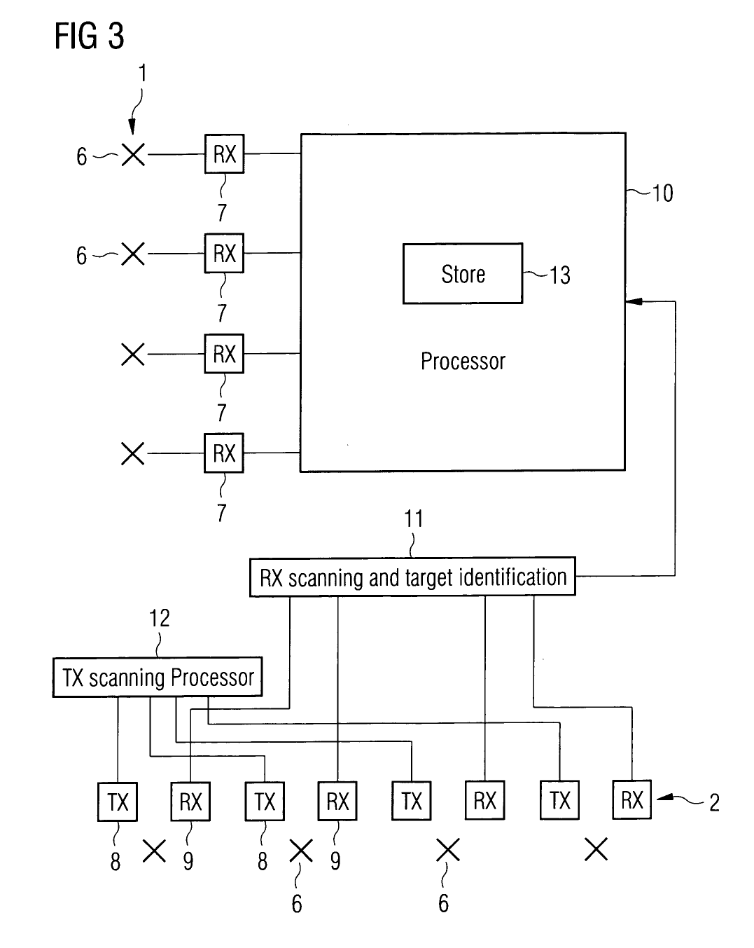

FIG. 3 is a block diagram of a radar system according to the present invention; and,

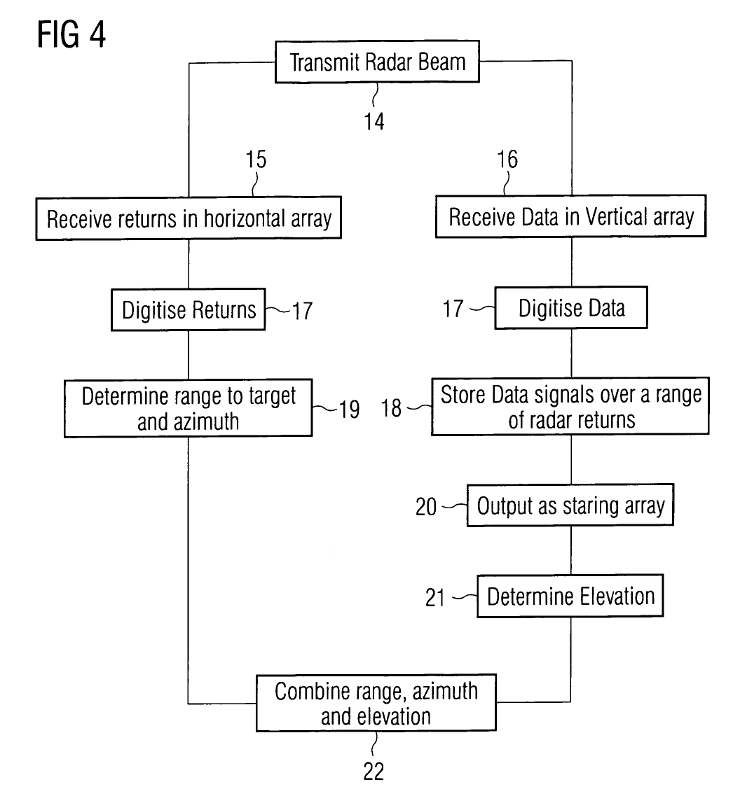

FIG. 4 is a flow diagram of the processing carried out in the system of FIG. 3.

In the present invention, crossed horizontal and vertical arrays are used, since the individual elements of the horizontal array have wide coverage, typically in elevation for the horizontal array and in azimuth for the vertical array. In this case, the horizontal array can transmit and receive, but the vertical array is only required to receive.

FIG. 1 illustrates a first example of a suitable crossed array. The crossed array is made up of a vertical array 1 and a horizontal array 2, in this case comprising multiple elements 3. Each element 3 of the vertical and horizontal arrays 1, 2 consists of crossed dipoles. It is assumed that the dipoles are connected to provide circular polarisation, although any polarisation is possible. In the example of FIG. 1 one element 4 is common to both the vertical and the horizontal arrays, which is convenient from the viewpoint of physical construction and provides a small, but useful saving in cost and complexity. A contrasting arrangement is shown in FIG. 2, where there is no common element, only a space 5, where an axis of each array 1, 2 of elements 3 intersects.

FIG. 3 illustrates a phased array radar system suitable for the present invention in more detail. The vertical array 1 comprises a number of antenna elements 6. Each vertical antenna array element provides an input to its own receive element 7. In the horizontal array, both transmit elements 8 and receive elements 9 are provided for each antenna element 6 of the array 2.

The output of each vertical array receiver 7 is fed into a processor 10, the processor having instructed each receiver as to the range at which it should set its antenna to stare, so that the desired image is produced. Determination of the range is made by the processor, using signals from the horizontal array 2 which have been processed in a receive scanning and target identification unit 11.

A transmit scanning processor 12 is coupled to each transmit element 8, so that a radar pulse is transmitted from the transmit elements 8 of the horizontal array 2. Radar return signals are received at the receive elements 9 and are fed into the receive scanning and target identification unit 11. Here, suitable values are determined to send to the processor 10 to control the range of the staring array.

The processing of the present invention is illustrated in more detail in FIG. 4. The horizontal array 2 of the radar operates in a conventional manner, scanning in azimuth by transmitting 14 a radar beam. The radar returns 15 enter the receive function 9 of the horizontal array via a steered beam that is pointing in substantially the same direction as it was when the radar pulse was transmitted from the transmit units 8. The return(s) from the target(s) are also being received 16 by the antenna elements 6 of the vertical array 1. The receivers 7 of each of the antenna elements 6 digitise 17 the applicable returned signals with a sampling rate substantially commensurate, according to Nyquist's sampling theorem, with respect to the bandwidth of those signals.

Conventionally, this is performed by RF down conversion followed by IF filtering, either at complex base band or at a modest IF, followed by analogue to digital conversion. The signals received over the range of possible radar returns are captured 18 into digital memory 13 for each of the elements 6 of the vertical array 1. The output 19 of the steered azimuth beam is a number of delays corresponding to returns from possible targets for each azimuth angle. At this stage the range to the target and the azimuth can be ascertained, but nothing is known about the elevation of the target.

For any given azimuth angle, the ranges of all potential targets can be determined through thresholding in combination with a suitable moving target indication (MTI) wherein only targets with Doppler commensurate with anticipated movement are identified.

Once the targets applicable for a given azimuth have been identified from the horizontally scanning radar array 2, the knowledge of these targets is used to assist in processing the stored received information in the processor 10 corresponding to the outputs from the vertical phased array. The stored outputs from the vertical phased array are combined 20 to form a staring array to determine 21 the elevation angle of arrival for the signals of interest. However, this processing is performed only for the delays corresponding to the identified targets and only for those azimuthal angles that have identified targets. For pulse radar this approach drastically reduces the amount of computation required, since no beam forming is required against the vast majority of range cells for which no target returns have been indicated.

If the mean number of targets is Nₜ and the number of range cells is N_{c} then the computational saving will be of the order of N_{c}/Nₜ. For pulse compression radar, the relative savings are the same, as explained below.

Suppose the number of elements in the vertical array 1 is Nₑ and the number of scanned beam directions is Nₛ. Let the mean correlation period for a pulse compression radar be over Nₚ chip elements. In a conventional array the number of accumulations would be either:—
N_{c}×Nₑ×Nₛ+N_{c}×Nₛ×Nₚ=N_{c}×Nₛ(Nₑ+Nₚ)
if the beams are formed before correlation, or
N_{c}×Nₚ×Nₑ+N_{c}×Nₛ×Nₑ=N_{c}×Nₑ(Nₚ+Nₛ)
if the beams are formed after correlation.

In the present invention N_{c} is replaced with Nₜ in the above expressions so that in both cases the number of computations is reduced by the same factor as for basic pulse radar. If generation of more beams than there are antenna elements 6 is required, then the above expressions indicate that it is better to correlate before beam forming rather than after. Nevertheless the benefit from selectively receiving according to the returns identified by the azimuth scan is the same in both cases.

Crossed phased array antennas are used as shown in FIGS. 1 and 2, in which the horizontal array 2 elements must have enough coverage in elevation to include the required range of elevation angles and the vertical array 1 elements must have enough coverage in azimuth to include the required range of azimuth angles. Transmission is in one array direction only, usually the horizontal, but reception is in both array directions. Data is captured in the receive-only array direction and returns are detected in the transmit array direction. The detected returns from the transmit array 2 direction are used to identify delays at which to perform staring array detection from the receive-only array 1 direction. The data from each of the horizontal and vertical arrays is then combined 22 in the processor to add elevation or azimuth angle information to range and azimuth or elevation angle information, depending upon which combination was chosen for which array. In addition there is the option of using a single common element 4 for both the horizontal and vertical arrays.

Since the transmitter is scanning in azimuth, for any given pulse, the returns seen in the elevation array will correspond to only one azimuth angle, even though the elevation array has broad coverage in azimuth. Thus, for example, it might be that a single return is seen at a given range from the azimuth array, but that when the computations are performed on the outputs of the elevation array it is then recognised that there were, in fact, more than one return at common slant range, but with different identifiable elevation angles.

1. A phased array radar comprising a first array of detectors in a first dimension; and a second array of detectors in a second, orthogonal, direction; wherein the first array of detectors both transmits and receives and the second array of detectors only receives; wherein the first array resolves in range and either azimuth or elevation; wherein the second array is a staring array that stares at targets at specified ranges determined by the first array; and wherein the second array resolves in the other of elevation or azimuth, accordingly.

2. A radar according to claim 1, wherein the first and second arrays are arranged as a crossed array formed of both horizontal and vertical arrays; and wherein the horizontal array scans in azimuth, so that the vertical array only needs to scan in elevation.

3. A radar according to claim 1, wherein the staring array is a vertical array.

4. A radar according to claim 1, wherein the staring array images at a determined range cell, plus or minus one range measurement cell.
